(19) United States
(12) Patent Application Publication
(10) Pub. No.: US 2019/0099751 A1
(43) Pub. Date: Apr. 4, 2019

(54) Compact Open-Channel Microfluidic Diodes Based On Two-Tier Capillary Junctions

(71) Applicant: REGENTS OF THE UNIVERSITY OF MINNESOTA, Minneapolis, MN (US)

(72) Inventors: Woo Jin Hyun, Saint Paul, MN (US); Lorraine F. Francis, Minnetonka, MN (US); Carl Daniel Frisbie, Saint Paul, MN (US)

(21) Appl. No.: 16/145,805

(22) Filed: Sep. 28, 2018

Related U.S. Application Data
(60) Provisional application No. 62/565,305, filed on Sep. 29, 2017.

(51) Int. Cl. B01L 3/00; B01F 5/04

(52) U.S. Cl. CPC B01L 3/5027; B01F 13/0059; B01F 5/0475

(57) ABSTRACT

An open-channel microfluidic diode includes a first reservoir, a second reservoir, a first channel and a second channel. The first channel is in fluid communication with the first reservoir, wherein the first channel is characterized by a first cross-sectional area. The second channel is in fluid communication with the first channel and the second reservoir, wherein the second channel is characterized by a second cross-sectional area greater than the first cross-sectional area. The first channel interacts with the second channel at a junction, and wherein liquid flows from the second channel to the first channel via capillary forces.

### CROSS-REFERENCE TO RELATED APPLICATIONS

This application claims priority to U.S. Provisional Application No. 62/565,305, filed on Sep. 29, 2017, and entitled “COMPACT OPEN-CHANNEL MICROFLUIDIC DIODES BASED ON TWO-TIER CAPILLARY JUNCTIONS”, the disclosure of which is incorporated by reference in its entirety.

### STATEMENT REGARDING FEDERALLY SPONSORED RESEARCH

This invention was made with Government support under Grant (or Contract) No. N00014-11-1-0690 awarded by the Office of Naval Research. The Government has certain rights in this invention.

### BACKGROUND

This invention relates generally to microfluidic devices, and in particular to an open-channel microfluidic diode.

Microfluidics refers to the behavior, control and manipulation of fluids that are geometrically constrained to a small, typically sub-millimeter scale. Fluid control of microfluids may be passive or active, wherein passive control relies on forces such as capillary forces to act upon the fluid, while active forces rely on micropumps and/or microvalves to act upon the fluid.

Open microfluidics is the science and technology of handling minute amounts of liquids in open microchannels, with applications ranging from chemical analysis, cell and molecular biology, medical diagnostics, and microelectronics. Open channels offer advantages over closed channels for microfluidic systems including simpler fabrication and more straightforward cleaning and surface modification. In addition, open microfluidic systems typically operate with capillary-driven flow, i.e., without a pump. Such autonomous operation is energy efficient and allows facile miniaturization of microfluidic systems, but the limited degree of liquid flow control necessitates creative strategies to achieve sophisticated function in open channel devices.

An important control element utilized in microfluidic applications is the microfluidic diode in which fluid is only allowed to flow in one direction. Microfluidic diodes allow simple mixing of fluids without cross contamination of reservoirs, for example.

### SUMMARY

According to one embodiment, an open-channel microfluidic diode includes a first reservoir, a second reservoir, a first channel and a second channel. The first channel is in fluid communication with the first reservoir, wherein the first channel is characterized by a first cross-sectional area. The second channel is in fluid communication with the first channel and the second reservoir, wherein the second channel is characterized by a second cross-sectional area greater than the first cross-sectional area. The first channel interacts with the second channel at a junction, and wherein liquid flows from the second channel to the first channel via capillary forces.

According to some embodiments, an open-channel microfluidic diode includes a first channel, a second channel, and a junction defined at the intersection of the first channel and the second channel. The first channel has a first cross-sectional geometry, an open end for connection to a first reservoir and a junction end opposite the open end. The second channel has a second cross-sectional geometry, an open end for connection to a second reservoir and a junction end opposite the open end, wherein the second cross-sectional geometry is greater than then the first cross-sectional geometry. The junction between the first channel and the second channel is defined by an edge angle α.

According to some embodiments, a method of fabricating a microfluidic diode includes first fabricating a first channel having a first cross-sectional area a_{S}. A second channel having a second cross-sectional area a_{L} is subsequently fabricated, wherein the second channel overlaps with the first channel to form a junction between the first channel and the second channel.

### BRIEF DESCRIPTION OF THE DRAWINGS

FIG. 1 is a perspective view of an open-channel microfluidic diode according to one embodiment.

FIGS. 2a and 2b are schematic diagrams illustrating the uni-directional flow of liquid through the open-channel microfluidic diode according to one embodiment.

FIG. 3 is a cross-sectional schematic of the geometry of a junction between small channel 302 and large channel 304 along with terminology utilized to describe the junction.

FIG. 4 is a top view of an open-channel microfluidic diode utilizing an S/L junction formed on a plastic substrate according to one embodiment.

FIG. 5 is a tilted scanning electron microscopy (SEM) image of an open-channel microfluidic diode connected between first and second reservoirs according to one embodiment.

FIG. 6a is a graph illustrating the flow of a fluid from a reservoir in the pinned direction over a period of time t according to one embodiment; FIG. 6b is image frames taken at discrete times monitoring the flow of fluid in the pinned direction; and FIG. 6c is a schematic that illustrates the flow of liquid in the pinned direction.

FIG. 7a is a graph illustrating the flow of a fluid from a reservoir in the free direction over a period of time t; FIG. 7b is a schematic diagram illustrating the flow of fluid from the reservoir in the free, and FIG. 7c is a schematic diagram illustrating the flow of liquid in the free direction.

FIGS. 8a-8f are optical images illustrating the flow of liquid in both the pinned direction and the free direction wherein the width of the small channel is varied; FIGS. 8g-8l are optical images illustrating the flow of liquid in both the pinned and free directions wherein the length of the channels is varied; and FIGS. 8m-8t are optical images illustrating the flow of liquid in both the pinned and free directions wherein the angle defining the junction between the small channel and the large channel is varied.

FIGS. 9a-9c are graphs illustrating the equilibrium contact angle, surface tension, and measured shear rate, respectively, for a plurality of different liquids having different liquid properties; FIGS. 9d-9f illustrate the flow of Silver, PEDOT:PSS and P3HT through microfluidic diode 900 in the pinned direction; FIGS. 9g-9i illustrate the flow of Silver, PEDOT:PSS and P3HT through microfluidic diode 900 in the free direction; and FIGS. 9j and 9g are scanning electron microscope (SEM) images of the junction shown in FIGS. 9d and 9g, respectively.

FIGS. 10a and 10b are diagrams illustrating steps utilized in forming a silicon master mold of the open-channel microfluidic diode utilizing photolithography techniques according to one embodiment.

FIGS. 11a-11d are diagrams illustrating steps utilized in forming an open-channel microfluidic diode in a polymer according to one embodiment.

### DETAILED DESCRIPTION

The present disclosure describes an open-channel microfluidic diode. The diode is comprised of a first and second open capillary channels are fluidically coupled to one another via a junction characterized by different cross-sectional dimensions. The difference in cross-sectional dimensions at the junction allows liquid to flow from the larger channel to the smaller channel but prevents the flow of liquid in the opposite direction. The unidirectional flow behavior is independent of liquid contact angle and surface tension, and also of changes in the channel dimensions, suggesting broad applicability for controlling flow in open-channel microfluidics.

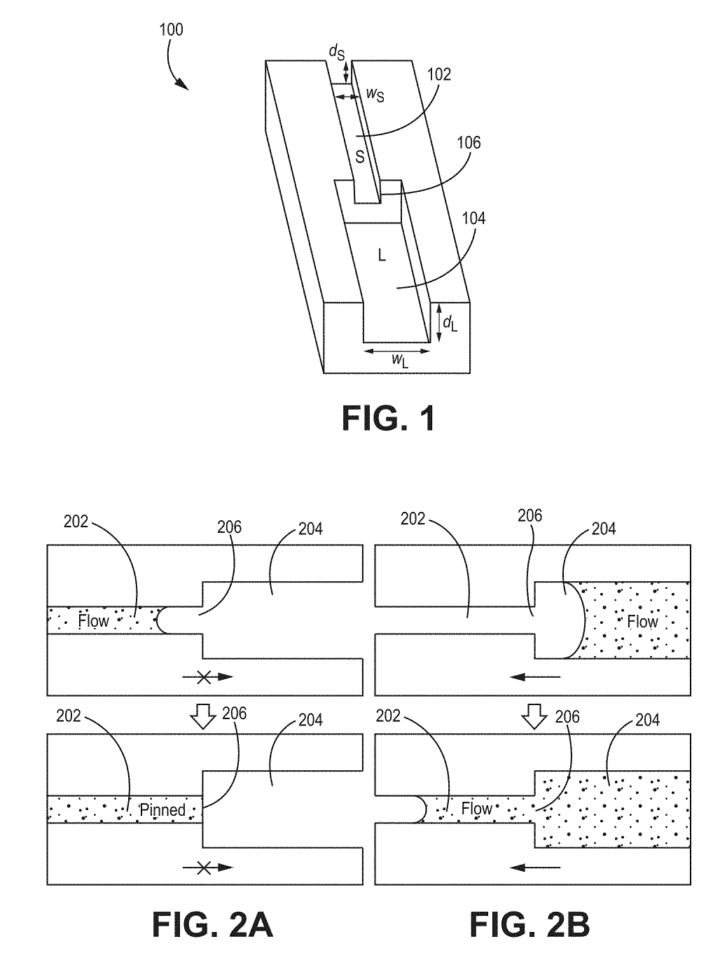

FIG. 1 is a perspective view of an open-channel microfluidic diode 100, comprised of small channel 102 and large channel 104. Small channel 102 is defined by a width w_{S} and a depth d_{S}. which defines a cross-sectional area associated with small channel 102. Likewise, Large channel 104 is defined by a width w_{L} and a depth d_{L}, which defines a cross-sectional area associated with large channel 102. The channels interact with one another at junction 106. Due to differences in the cross-sectional area of the respective large and small channels, liquid flows unidirectionally from the larger channel to the smaller channel (i.e. the flowing direction) but is prevented from flowing in the opposite direction (i.e. pinned direction).

In the embodiment shown in FIG. 1, both small channel 102 and large channel 104 are open-channels wherein the end of the channel opposite the junction is open. For example, the open channel may be connected to a reservoir, wherein liquid stored by the reservoir is directed through the channel by capillary action.

In the embodiment shown in FIG. 1, the width w_{S} of small channel 102 is less than the width w_{L} of large channel 104. Similarly, the depth d_{S} of small channel 102 is less than the depth d_{L} of large channel 104. In other embodiments, the relationship between the width and depth of the respective channels may be varied so long as the cross-sectional area of small channel 102 is less than the cross-sectional area of large channel 104.

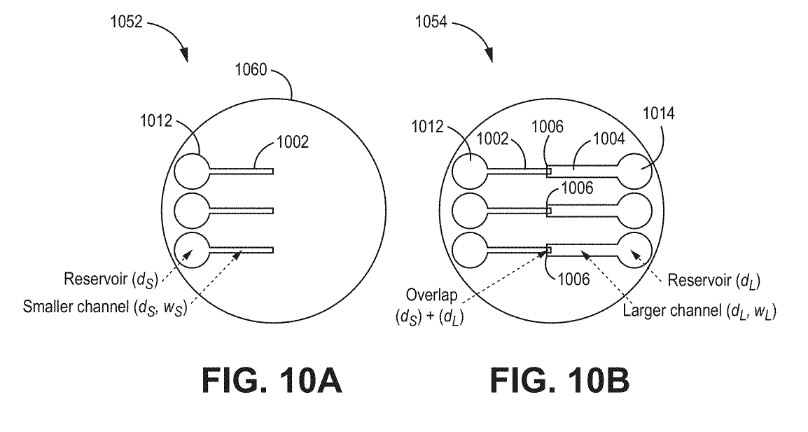

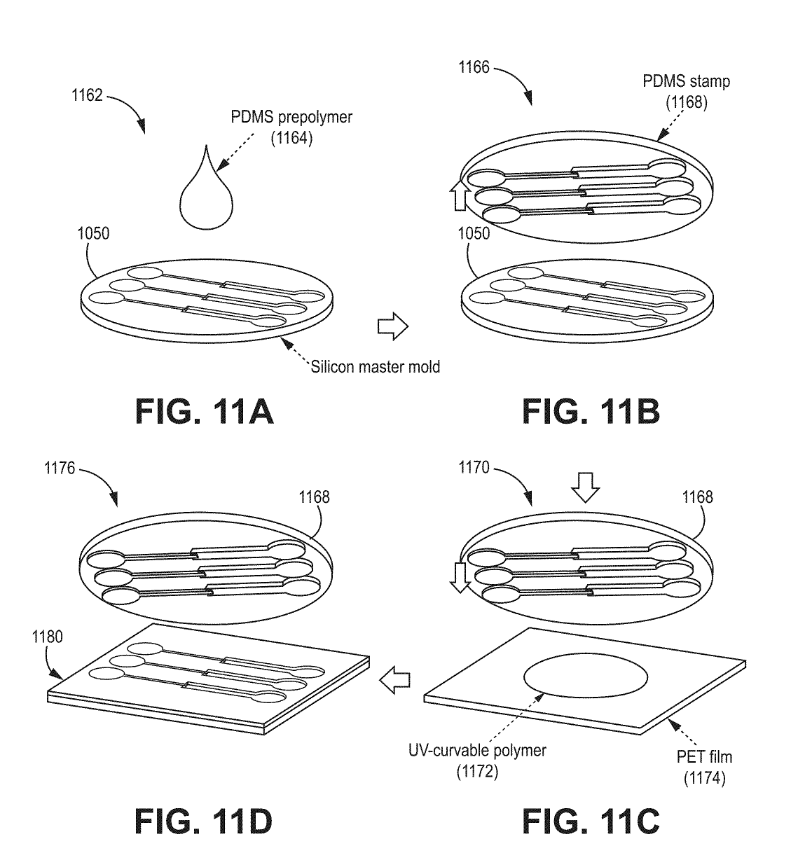

As discussed in more detail with respect to FIGS. 10 and 11, the channel and junction structure of the open-channel microfluidic diode 100 may be fabricated on a silicon wafer using photolithography processes. In some embodiments, the silicon wafer patterned with the open-channel microfluidic diode may be utilized directly in applications or may be utilized as a master mold for fabricating the microfluidic diode onto other substrates, such a UV-curable polymer.

FIGS. 2a and 2b are schematic diagrams illustrating the uni-directional flow of liquid through the open-channel microfluidic diode 200 according to one embodiment. In particular, FIG. 2a illustrates the flow of liquid through small channel 202 towards large channel 204, wherein the liquid is pinned at junction 206 between small channel 202 and large channel 204. FIG. 2b illustrates the flow of liquid through large channel 204 towards small channel 202 wherein the liquid is allowed to flow through junction 206 into small channel 202. These examples illustrate the uni-directional flow of liquid through the microfluidic diode.

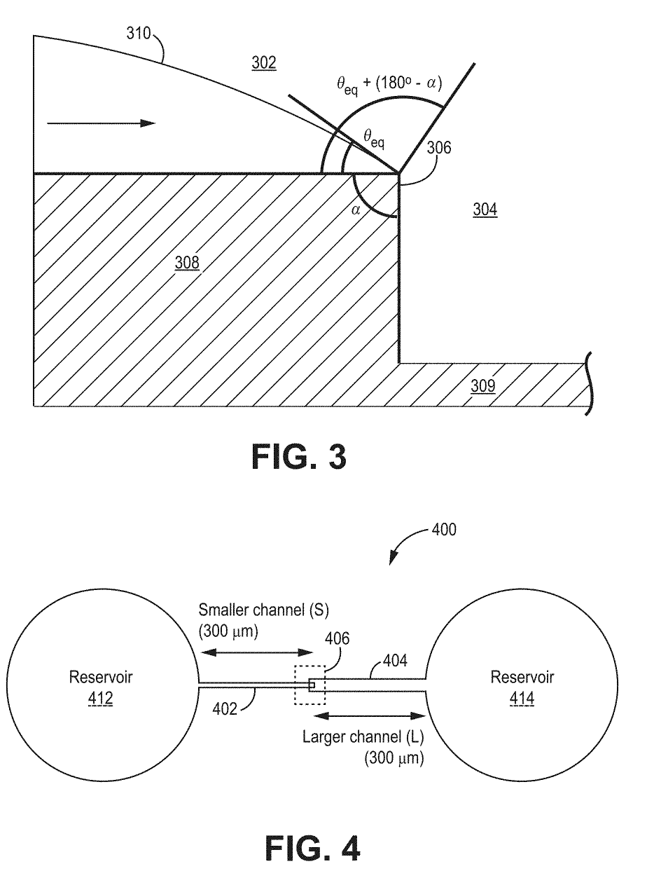

FIG. 3 is a cross-sectional schematic of the geometry of a junction between small channel 302 and large channel 304 along with terminology utilized to describe the junction. In these embodiments, each channel is comprised of at least two sidewalls and a bottom wall although in the cross-sectional view shown in FIG. 3 only bottom wall portion 308 of the small channel 302 and bottom wall portion 309 of the large channel 304 are visible. At the termination of small channel 302 at junction 306, the sidewalls and bottom portion 308 form one or more angles that define the geometry between small channel 302 and large channel 304. For example, in the embodiment shown in FIG. 3, the angle α defined by the termination of bottom portion 308 at junction 306 is approximately 900. In other embodiments, this angle may be modified based on the application to less than or greater than 90° depending on the application.

FIG. 3 also illustrates the equilibrium contact angle associated with the liquid. The equilibrium contact angle θ_{eq} is defined as the angle the liquid makes with the solid channel, with angles ranging from approximately 0° to 150° depending on the properties of the liquid and the solid on which the liquid is located. In the embodiment shown in FIG. 3, the equilibrium contact angle θ_{eq} is approximately 45°.

Whether the liquid front (labeled 310) is allowed to pass over the edge defined by angle α depends on whether the contact angle θ (estimated as equilibrium contact angle θ_{eq}) exceeds a critical angle θ_{cr}, expressed by the following relationship:

θ_{cr}=θ_{eq}+(180°−α) Equation 1

wherein θ_{eq} and α are the equilibrium contact angle of the liquid on the channel material and the edge angle, respectively. In the embodiment shown in FIG. 3, the equilibrium contact angle θ_{eq} is less than the critical angle θ_{cr}, such that the liquid is not allowed to pass over the edge defined by angle α. As a result, liquid flowing from the small channel 302 to the large channel 304 is pinned by the junction 306 defined at the termination of the small channel 302.

FIG. 4 is a top view of an open-channel microfluidic diode 400 utilizing a Small/Large (S/L) junction 406 formed on a plastic substrate according to one embodiment. The embodiment shown in FIG. 4 illustrates open-channel microfluidic diode 400 coupled to first reservoir 412 and second reservoir 414. First reservoir 412 is fluidically coupled to small channel 402 and second reservoir 414 is fluidically coupled to large channel 404 with small channel 402 and large channel 404 being fluidically coupled (unidirectionally) to one another via junction 406. In the embodiment shown in FIG. 4, both small channel 402 and large channel 404 are approximately the same length (e.g., 300 μm). The open-channel microfluidic diode 400—and in particular the junction 406 between small channel 402 and large channel 404—allows liquid to flow from second reservoir 414 to first reservoir 412 but prevents the flow of liquid from first reservoir 412 to second reservoir 414. In the embodiment shown in FIG. 4, the width of small channel 402 is smaller than the width of large channel 404. In some embodiments, the depth of small channel 402 is also smaller than the depth of large channel 404.

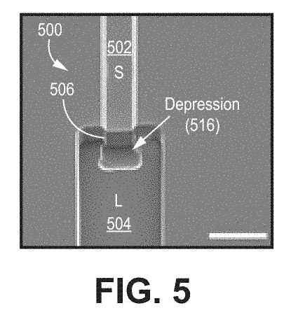

FIG. 5 is a tilted scanning electron microscopy (SEM) image of an open-channel microfluidic diode 500 illustrating in more detail the structure of junction 506 according to one embodiment. In particular, this embodiment illustrates the structure resulting from a two-step photolithography process in which small channel 502 is etched via a photolithography process, and large channel 504 is subsequently etched such that large channel 504 slightly overlaps with small channel 502. As a result, a slight depression 516 is visible within large channel 504 as a result of the previous etch of small channel 502. Locating depression 516 within large channel 504—as opposed to within small channel 502—does not have a material effect on the unilateral flow characteristics of open-channel microfluidic device 500. A benefit of fabricating the small channel 502 and then subsequently fabricating the large channel 504 is that it allows the dimensions of the small channel (e.g., width, depth) to be smaller than the large channel while ensuring overlap between the small channel 502 and the large channel 504.

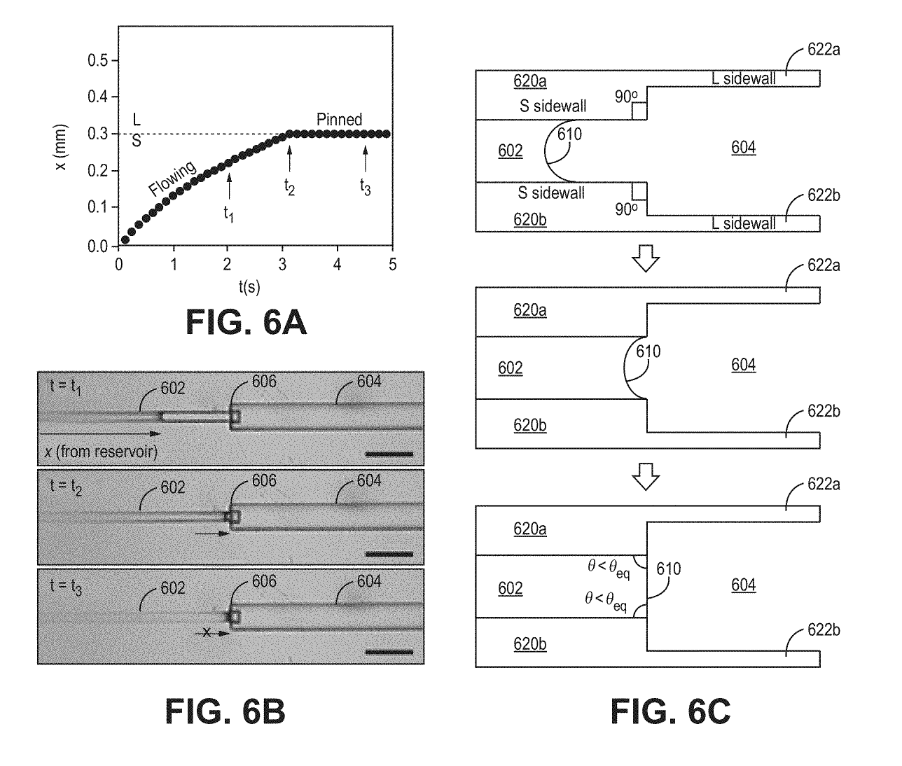

FIG. 6a is a graph illustrating the flow of a fluid from a reservoir in the pinned direction over a period of time t according to one embodiment; FIG. 6b illustrates image frames taken at discrete times t₁, t₂, and t₃ monitoring the flow of fluid in the pinned direction, and FIG. 6c is a schematic that illustrates the flow of liquid in the pinned direction according to one embodiment.

As illustrated by FIGS. 6a-6c, fluid from a reservoir begins to flow through small channel 602 (as shown in FIGS. 6b and 6c) toward large channel 604. When the liquid reaches junction 606, however, the fluid flow is halted at the junction between small channel 602 and large channel 604. This is illustrated in FIG. 6a, which illustrates the distance d the fluid has flowed from the reservoir (d=0) toward the junction 606 over time t. As shown in FIG. 6a, the distance d traveled by the fluid increases until the fluid reaches junction 606 at time t₂. Due to the difference in cross-sectional area between the small channel 602 and large channel 604, the flow of fluid is halted. Subsequent to time t₂. the fluid does not flow in the d direction (i.e., is pinned), thereby preventing fluid from flowing into large channel 604.

FIG. 6b illustrates the flow of fluid at times t₁, t₂ and t₃ seconds, respectively from top to bottom. At time t₁ (top image), the fluid is moving toward junction 606 from the reservoir. At time t₂ the fluid reaches junction 606. At time t₃, rather than flowing into large channel 604, the fluid is pinned at junction 606.

FIG. 6c is a schematic diagram illustrating the junction geometry and the effect of the junction geometry on fluid flow in the pinned direction. In the embodiment shown in FIG. 6c, junction 606 includes three angles of approximately 90° at the termination of small channel 602 at the larger channel 604. These angles include opposing small channel sidewalls 620a. 620b and bottom of the small channel (not shown) and opposing large channel sidewalls 622a, 622b and bottom of the large channel. As described with respect to FIG. 3, above, the liquid front 610 is allowed to pass over these sharp edges only when its contact angle (θ) (estimated as the equilibrium contact angle θ_{eq}) exceeds the critical value (θ_{cr}). This condition can be expressed by the following relationship:

θ_{cr}=θ_{eq}+(180°−α) Equation 1

wherein θ_{eq} and α are the equilibrium contact angle of the liquid on the channel material and the edge angle, respectively. As illustrated in FIG. 6c, the contact angle θ is less than the critical angle θ_{cr}, and therefore the liquid is pinned by junction 606. However, liquid flow continues, driven by negative curvature of the front 610 and the corresponding capillary pressure gradient, leading to a buildup of liquid on the small channel side of the junction and a gradual reduction of curvature of the front 610. The buildup continues until the curvature of the liquid front is approximately zero, as shown in the bottom image in FIG. 6c. At this point the capillary pressure gradient disappears, flow ceases, and the contact angle θ_{eq} of the liquid with the wall material at the three edges is still less than the critical angle θ_{cr}. The liquid front becomes firmly pinned on the small channel side of the junction 606.

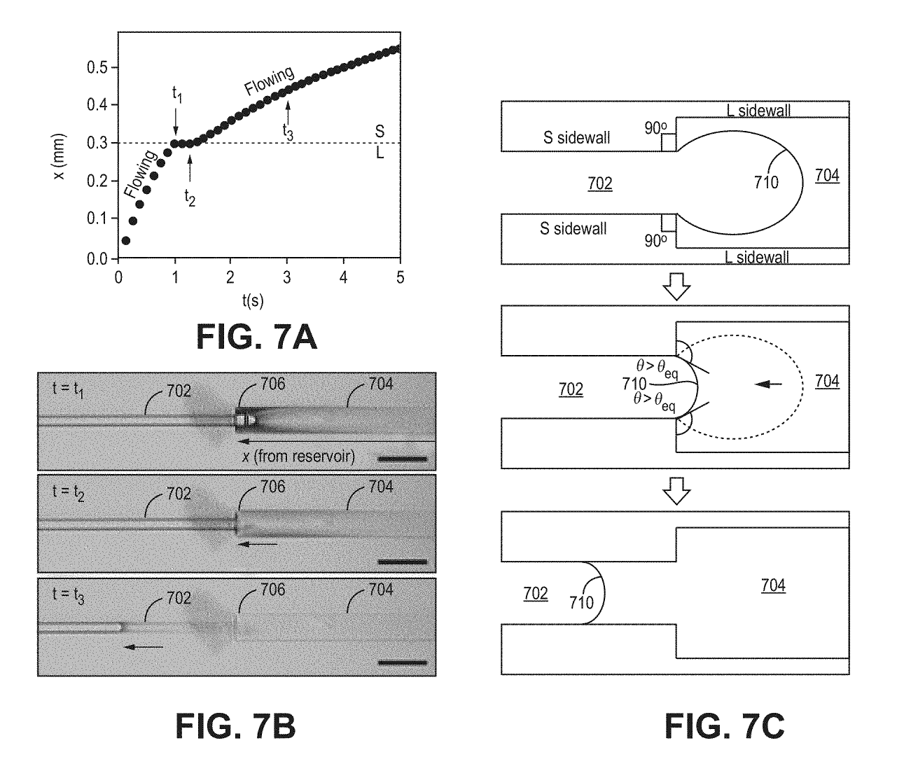

FIG. 7a is a graph illustrating the flow of a fluid from a reservoir in the free direction over a period of time t according to one embodiment; FIG. 7b is a schematic diagram illustrating the flow of fluid from the reservoir in the free direction (from the large channel 704 to small channel 702), and FIG. 7c is a schematic diagram illustrating the flow of liquid in the free direction according to one embodiment.

As illustrated by FIGS. 7a-7c, fluid from a reservoir begins to flow through large channel 704 (as shown in FIGS. 7b and 7c) toward small channel 702. In contrast with that shown in FIGS. 6a-6c, the liquid passes through junction 706 into small channel 702. This is illustrated in FIG. 7a, which illustrates the distance d fluid has flowed from the second reservoir (d=0) toward the junction 706 over time t. As shown in FIG. 7a, the distance d traveled by the fluid increases until the fluid reaches junction 706 at time t₂. The flow of the liquid is slowed as the liquid interacts with junction 706, but subsequent to time t₂, the liquid continues flowing away from the second reservoir and into small channel 702. Liquid is therefore allowed to flow freely in this direction—from large channel 704 to small channel 702. In the free direction, capillary flow never ceases because the capillary pressure gradient does not vanish. Initially, the approaching liquid in large channel 704 wets the channel surfaces. Due to front curvature 710, there is still a significant capillary pressure gradient that continues to drive the flow. Continued liquid filling on the large channel side of junction 706 produces the situation shown in the middle image of FIG. 7c, in which the curvature of the front 710 is still strongly negative, and the increasing liquid volume in the large channel side of junction 706 drives a steady increase in θ on the walls and channel bottom. In this situation, where liquid buildup continues, the flow criterion θ_{eq}>θ_{cr} ultimately occurs and the front is free to cross into the small channel 702. In short, transport in the free flow direction happens because the geometry of the walls on the large channel side of junction 706 preserves the capillary-driven flow until θ_{eq}>θ_{cr}. As we discuss further below, the two-tier geometry turns out to be a completely general strategy to achieving rectified flow.

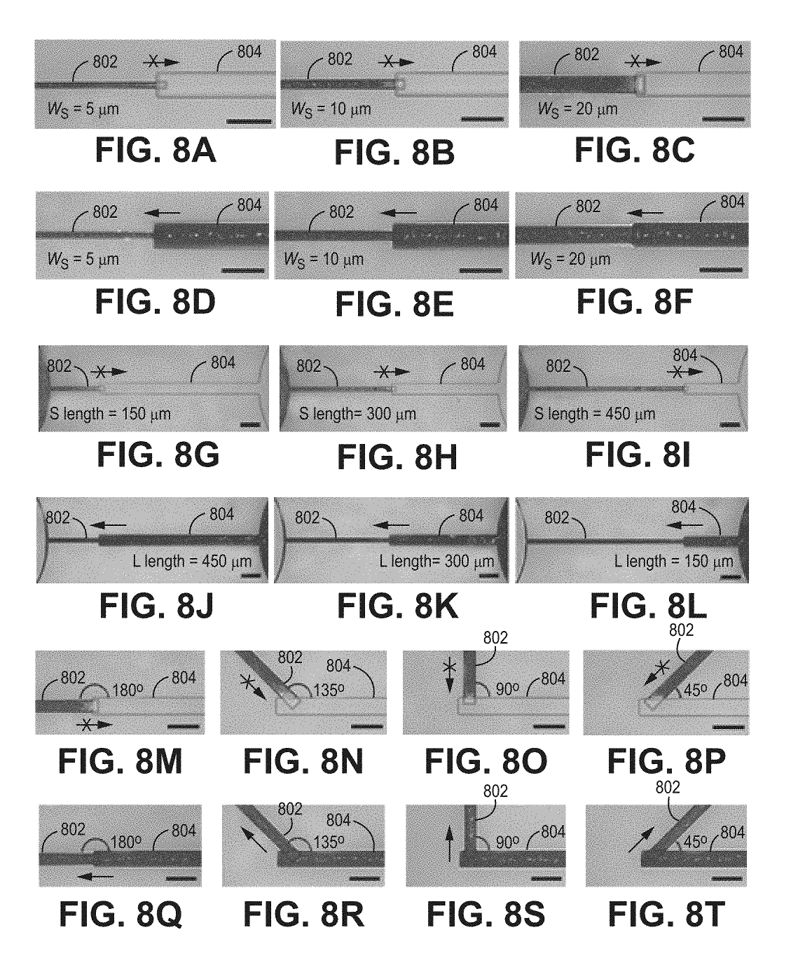

FIGS. 8a-8f are optical images illustrating the flow of liquid in both the pinned direction and the free direction wherein the width of the small channel is varied; FIGS. 8g-8l are optical images illustrating the flow of liquid in both the pinned and free directions wherein the length of the channels is varied; and FIGS. 8m-8t are optical images illustrating the flow of liquid in both the pinned and free directions wherein the angle defining the junction between the small channel and the large channel is varied.

In the embodiments shown in FIGS. 8a-8c, the width wₛ of small channel 802 is approximately 5 μm, 10 μm, and 20 μm, respectively, and in each case is less than the width of the large channel 804 (e.g., approximately 30 μm). In addition, the depth d of small channel 802 is approximately 3.4 μm and the depth d_{L} of large channel 804 is approximately 9.4 μm In each case, liquid flow from small channel 802 to large channel 804 is pinned by the junction 806 between the two channels, providing evidence that a plurality of different channel widths may be utilized while retaining the uni-directional characteristics of microfluidic diode 800.

In the embodiments shown in FIGS. 8d-8f, the same dimensions provided in FIGS. 8a-8c are utilized, but with liquid flowing from the large channel 804 to the small channel 802. In each case, the liquid front is able to traverse the junction 806 between large channel 804 and small channel 802 despite the different widths of small channel 802.

In the embodiments shown in FIGS. 8g-8i, the length of small channel 802 is approximately 150 μm, 300 μm, and 450 μm, respectively. Conversely, the length of the large channel 804 is approximately 450 μm, 300 μm, and 150 μm, respectively. In each embodiment, the length of small channel 802 does not adversely affect the ability of junction 806 to pin the flow of liquid traveling from small channel 802 to large channel 804, providing evidence that a plurality of different channel lengths may be utilized while retaining the uni-directional characteristics of microfluidic diode 800.

In the embodiments shown in FIGS. 8j-8l, the same dimensions provided in FIGS. 8g-8i are utilized, but with liquid flowing from the large channel 804 to the small channel 802. In the embodiments shown in FIGS. 8j-8l, the length of large channel 804 is approximately 450 μm, 300 μm, and 150 μm, respectively. In each case, the liquid front is able to traverse the junction 806 between large channel 804 and small channel 802 in the free direction despite the different lengths of large channel 804.

In the embodiments shown in FIGS. 8m-8p, the angle defining the junction between the small channel and the large channel is 180°, 135°, 90°, and 45°, respectively. The junction angle (as shown in FIGS. 8m-8p) is different from the edge angle, which is the angle defined between the walls of the small channel and the large channel. The junction angle refers to the angle between the respective channels themselves assuming each channel is defined by a centerline axis. In each case, the angle defining the junction between the respective channels does not adversely affect the ability of junction 806 to pin the flow of liquid traveling from small channel 802 to large channel 804.

Similarly, in the embodiments shown in FIGS. 8q-8t, the angle defining the junction between the small channel and the large channel is 180°, 135°, 90°, and 45°, respectively, but with liquid flowing in the free direction from large channel 804 to small channel 802. In each embodiment, the angle defining the junction between the respective channels does not adversely affect the ability of junction 806 to allow the flow of liquid across junction 806.

In particular, the various angles illustrated to provide the desired uni-directional flow of liquid provides insight into the mechanism responsible for conveying the liquid across the function. In particular, the rate at which liquid flows through the channels depends, at least in part, on the channel width and depth. In general, the liquid moves faster through larger channels than through small channels, implying that the liquid front in the free direction approaches the junction with higher velocity than that in the pinning direction. While the faster velocity may aid in helping the liquid pass over the junction edge into the smaller channel, the embodiments shown in FIGS. 8r-8t illustrate that other mechanisms other than velocity difference are responsible for the unidirectional flow across the junction. In particular, FIG. 8s illustrates a junction having a 90° angle between the small channel 802 and the large channel 804 (i.e., where small channel 802 is connected to a sidewall of large channel 804 to prevent the liquid front from hitting the entrance to the small channel directly). Despite losing the momentum due to the indirect route, the liquid crosses from large channel 804 to small channel 802 in the 90° junction, similar to the liquid crossing in the straight junction, revealing that the liquid flow in the free direction does not result from the faster velocity in the large channel.

The mechanism of junction flow can also be probed by examining the influence of the edge angle α on the flow behavior based on the embodiment utilizing a junction angle of 135° as shown in FIGS. 8n and 8r. Unlike the straight junction (FIGS. 8m and 8q) and the right-angle junction (FIGS. 8o and 8s), wherein the sidewall edges having the same edge angle α (i.e., 90°), the 135° junction has sidewall edges with different edge angles α. For example, while the right sidewall edge has an angle of 135°, the left sidewall has an angle of 45°. Using Equation 1, defined above, the right sidewall edge can be defined as (θ_{cr}=θ_{eq}+45°) and the left sidewall edge can be defined as (θ_{cr}=θ_{eq}+135°). For the free flow direction, the expectation then is that the Gibbs criterion should be met first on the right sidewall with the larger a because it has the lower θ_{cr}. Indeed, while the liquid front in the straight junction (FIG. 8q) and 90° junctions (FIG. 8s) crosses over by creating liquid fingers or wedges in both corners of small channel 802 at the same time, the liquid front in the 135° junction generates one wedge in the right corner of small channel 802 first and forms the other wedge in the left corner later when the entire contact line has passed over the bottom edge. Thus, there is a clear dependence of the flow behavior on α that is in accordance with the expectations based on the Gibbs criterion.

The embodiments shown in FIGS. 8a-8g illustrates that microfluidic diodes are not substantially sensitive to variations in geometry including width, depth, length, and angle of the small and large channels employed in the microfluidic diode design. In particular, embodiments shown in FIGS. 8a-8f utilize different widths of the small channel w_{S}, different lengths of the small and large channels (FIGS. 8g-8l), and different channel angles between the small and large channels (FIGS. 8m-8t). All junctions exhibited unidirectional liquid flow consistently.

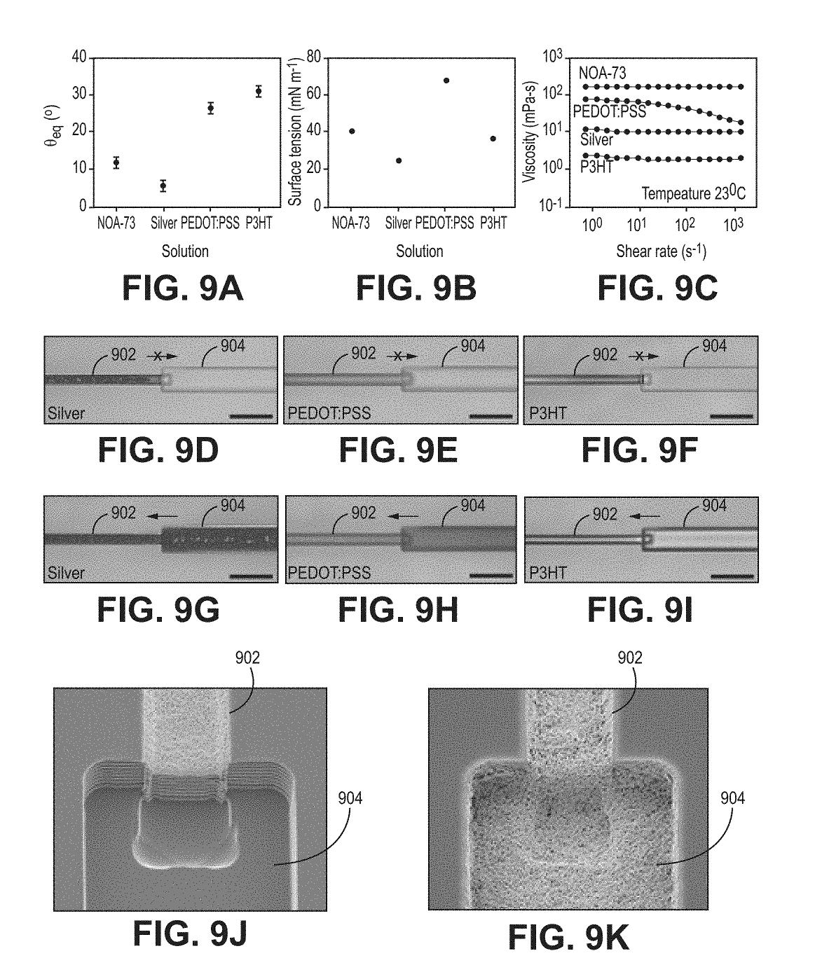

FIGS. 9a-9c are graphs illustrating the equilibrium contact angle, surface tension, and measured shear rate, respectively, for a plurality of different liquids having different liquid properties. Liquids tested include Norland Optical Adhesive 73 (NOA-73). Silver, poly polystyrene sulfonate (PEDOT: PSS), and Regioregular poly(3-hexylthiophene-2,5-diyl) (P3HT). FIG. 9a illustrates the equilibrium contact angle for each of the tested liquids, wherein NOA-73 is shown to have an equilibrium contact angle of approximately 120, Silver is shown to have an equilibrium contact angle of approximately 60, PEDOT: PSS is shown to have an equilibrium contact angle of approximately 26°, and P3HT is shown to have an equilibrium contact angle of approximately 31°. FIG. 9b illustrates the surface tension associated with each of the tested liquids, wherein NOA-73 exhibits a surface tension of approximately 40 mNm⁻¹, Silver exhibits a surface tension of approximately 23 mNm⁻¹. PEDOT: PSS exhibits a surface tension of approximately 70 mNm⁻¹, and P3HT exhibits a surface tension of approximately 38 mNm⁻¹. FIG. 9c illustrates the viscosity of each of the fluids at various temperatures, wherein from highest to lowest the viscosity associated with the plurality of liquids include NOA-73, PEDOT:PSS, Silver, and P3HT.

FIGS. 9d-9f illustrate the flow of Silver. PEDOT:PSS and P3HT through microfluidic diode 900 in the pinned direction. In the embodiment shown in FIGS. 9d-9f, the following dimensions were utilized: w_{S}=10 μm, d_{S}=3.4 μm, w_{L}=30 μm, and d_{L}=9.4 μm, respectively, although in other embodiments other channel geometries may be utilized. Despite differences in equilibrium contact angle, surface tension and viscosity shown in FIGS. 9a-9c, the microfluidic diode 900 prevents the flow of the liquid across junction 906, successfully pinning the liquid.

FIGS. 9g-9i illustrate the flow of Silver, PEDOT:PSS and P3HT through microfluidic diode 900 in the free direction. The channel dimensions utilized in FIGS. 9d-9f are utilized as well in FIGS. 9g-9i, although in other embodiments other channel geometries may be utilized. Despite differences in equilibrium contact angle, surface tension and viscosity shown in FIGS. 9a-9c, the microfluidic diode 900 allows the flow of the liquid across junction 906. The results shown in FIGS. 9d-9i illustrate the ability to uni-directionally control the flow of liquid.

FIGS. 9j and 9g are scanning electron microscope (SEM) images of the junction 906 shown in FIGS. 9d and 9g, respectively. In the embodiment shown in FIG. 9j, the liquid is pinned on the small channel side of junction 906. In the embodiment shown in FIG. 9k, the liquid is allowed to flow across junction 906 from large channel 904 into small channel 902.

FIGS. 10A and 10B are diagrams illustrating steps utilized in forming a silicon master mold 1050 of the open-channel microfluidic diode utilizing photolithography techniques according to one embodiment. In particular, in the embodiment shown in FIG. 10, silicon master mold is fabricated using two photolithography cycles.

At step 1052, a silicon wafer 1060 was pre-baked at a first temperature (e.g., 115° C.) for a first period of time (e.g., 1 min), vapor-coated with hexamethyldisilazane (e.g., KMG Electronic Chemicals) for a period of time (e.g., 3 min), and spin-coated with photoresist (Microposit S1813, Dow) (e.g., 2000 rpm) for a period of time (e.g., 30 seconds). After soft-baking at a second temperature (e.g., 115° C.) for a period of time (e.g., 1 min) and UV exposure with a photomask using a mask aligner (e.g., MA6, Karl Suss), the wafer 1060 is immersed in a developer (e.g., Microposit 351, Dow) diluted with deionized water (e.g., 1:5 v/v) for a period of time (e.g., 40 s), and rinsed with deionized water. The features were then etched by reactive ion etching (e.g., 320, Surface Technology Systems), followed by rinsing the photoresist with acetone, ethanol, isopropanol, and deionized water, sequentially. The result of the first photolithography process is utilized to form small channel 1002 and first reservoir 1012 in silicon substrate 1060. The geometry of small channel 1002 is defined by the first photolithography process to provide the desired channel width w_{S} and the desired channel depth d_{S}. In the embodiment shown in FIG. 10, first reservoir 1012 has a depth d_{S} equal to the depth of small channel 1002.

At step 1054, the second photolithography cycle is initiated to form the large channel. At this step, the silicon wafer is prebaked at a temperature (e.g., 200° C.) for a period of time (e.g., 5 min), vapor-coated with hexamethyldisilanzane for a period of time (e.g., 3 min), and spin-coated with photoresist (e.g., AZ 9260, MicroChemicals) (e.g., 300 rpm) for a period of time (e.g., 10 s) and at a higher revolution (e.g., 3000 rpm) for a period of time (e.g., 60 s), sequentially. After soft-baking at a temperature (e.g., 110° C.) for a period of time (e.g., 165 s), the photoresist was exposed to UV light through a photomask using the mask aligner. The wafer was immersed in a developer solution (e.g., AZ 400K, Merck Performance Materials) diluted with deionized water (e.g., 1:4 v/v) for 4 min, and rinsed with deionized water. The features were then etched by reactive ion etching (e.g., SLR-770, Plasma-Therm), and the photoresist was rinsed with acetone, ethanol, isopropanol, and deionized water, sequentially. Finally, the silicon wafer was submerged in piranha solution of hydrogen peroxide and sulfuric acid (e.g., 1:1 v/v) on a hotplate (e.g., 120° C.) for a period of time (e.g., 30 min) to clean residual photoresist. The result of the second photolithography process is utilized to form large channel 1004 and second reservoir 1014 in silicon substrate 1060. The geometry of large channel 1004 is defined by the second photolithography process to provide the desired channel width w_{L} and the desired channel depth d_{L}.

In some embodiments, overlap in photolithographic steps 1052 and 1054 at junction 1006 results in a slight depression 1016 on the large channel side of junction 1006, due to the area being subject to both photolithography steps. In the embodiment shown in FIG. 10, the depression 1016 has a depth of (d_{S}+d_{L}). In addition, in the embodiment shown in FIG. 10, second reservoir has a depth d_{L} equal to the depth of large channel 1004. In this way, the depth of second reservoir 1014 may be larger than the depth of first reservoir 1012. In embodiments in which different depths are required, additional photolithography steps may be utilized to obtain the desired depths/widths of first channel 1002, second channel 1004, first reservoir 1012, and second reservoir 1014. As discussed above, the silicon master mold 1050 formed on silicon substrate 1060 may be utilized as a microfluidic diode. In other embodiments, however, the silicon master mold 1050 is utilized as a mold to form microfluidic diode devices out of suitable material, such as a photocurable polymer.

FIGS. 11A-11D are diagrams illustrating steps utilized in forming an open-channel microfluidic diode in a polymer. In the embodiment shown in FIG. 11, the silicon master mold 1050 (for example, fabricated as described in FIGS. 10A, 10B) is utilized to form the open-channel microfluidic diode. At step 1162 shown in FIG. 11A, silicon master mold 1050 is silane-treated in a vacuum chamber with a mixture (e.g., 0.2 mL) of trichloro(1H,1H, 2H,2H-perfluorooctyl)silane (Sigma-Aldrich) for a period of time (e.g., 4 hours). A mixture of polydimethylsiloxane (PDMS) monomer 1164 and its curing agent (e.g., 10:1 w/w, Sylgard 184, Dow Corning) is poured onto the master mold, the composition is cured in an oven at a temperature (e.g., 70° C.) for a period of time (e.g., 3 hours). At step 1166 shown in FIG. 11B, the PDMS stamp 1168 is peeled off from the master mold 1050 and post-cured in an oven at a temperature (e.g., 120° C.) for a period of time (e.g., 2 hours). The result of this step is a polymer stamp 1168 having the dimensions defined by the silicon master mold 1050.

At step 1170 shown in FIG. 11C, a UV-curable polymer 1172 (e.g., NOA-73, Norland Products) is poured on a polyethylene terephthalate (PET) film 1174, previously plasma-treated (e.g., PDC-32G, Harrick Plasma) for a period of time (e.g., 3 min), and pressed by the PDMS stamp 1168. After exposing the photopolymer to UV light (e.g., wavelength: 365 nm, LED SPOT 100, Dr. Hönle AG) for a period of time (e.g., 90 seconds), at step 1176 (shown in FIG. 11D) the stamp 1168 is delaminated from the cured photopolymer having microfluidic diode device 1180. The result is an open-channel microfluidic diode having dimensions provided in the silicon master mold 1050.

Overall, the two-tier capillary driven microfluidic diode described herein provides highly reproducible and completely rectified liquid flow necessary for many envisioned applications of open microfluidics. The fabrication of the microfluidic diode is simple (two steps) and can be as a mold to replicate the microfluidic design via microreplicaiton or imprinting. The microfluidic diode may be implemented in a variety of materials, including glass and a variety of plastics, and therefore offers a reliable solution to manipulate capillary flow in a variety of microfluidic technologies.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An open-channel microfluidic diode comprising:
a first reservoir;
a second reservoir;
a first channel in fluid communication with the first reservoir, wherein the first channel is characterized by a first cross-sectional area; and
a second channel in fluid communication with the first channel and the second reservoir, wherein the second channel is characterized by a second cross-sectional area greater than the first cross-sectional area;
wherein the first channel interacts with the second channel at a junction between the first and second channels, and wherein liquid flows uni-directionally from the second channel to the first channel via capillary forces.

2. The open-channel microfluidic diode of claim 1, wherein the first channel is further characterized by a first channel depth and a first channel width, and the second channel is further characterized by a second channel depth and a second channel width, wherein the second channel depth is greater than the first channel depth and the second channel width is greater than the first channel width.

3. The open-channel microfluidic diode of claim 1, wherein the first channel is further characterized by a first channel depth and the second channel is further characterized by a second channel depth, wherein the second channel depth is greater than the first channel depth.

4. The open-channel microfluidic diode of claim 1, wherein the first channel is further characterized by a first channel width and the second channel is further characterized by a second channel width, wherein the second channel width is greater than the first channel width.

5. The open-channel microfluidic diode of claim 1, further including:
a junction defined between the first channel and the second channel, wherein the junction is defined by an edge angle α.

6. The open-channel microfluidic diode of claim 5, wherein a liquid front is prevented from passing through the junction defined by the edge angle α if a contact angle θ of the liquid front is less than a critical angle θ_{cr}, wherein the critical angle θ_{cr} is defined as 0+(180°−α)

7. The open-channel microfluidic diode of claim 1, wherein the open-channel microfluidic diode is fabricated on a silicon wafer.

8. The open-channel microfluidic diode of claim 1, wherein the first channel and the second channel form a junction angle.

9. The open-channel microfluidic diode of claim 8, wherein the junction angle may be between 180 degrees and 45 degrees.

10. An open-channel microfluidic diode comprising:
a first channel having a first cross-sectional geometry, an open end for connection to a first reservoir and a junction end opposite the open end;
a second channel having a second cross-sectional geometry, an open end for connection to a second reservoir and a junction end opposite the open end, wherein the second cross-sectional geometry is greater than then the first cross-sectional geometry; and
a junction defined at the intersection of the junction end of the first channel and the junction end of the second channel, wherein the junction is defined by an edge angle α.

11. The open-channel microfluidic diode of claim 10, wherein the edge angle α defined by the junction allows fluid to flow from the second channel to the first channel and prevents fluid from flowing from the first channel to the second channel.

12. The open-channel microfluidic diode of claim 10, wherein the flow of fluid within the open-channel microfluidic diode is determined by capillary forces.

13. The open-channel microfluidic diode of claim 10, wherein fluid flowing from the first channel to the second channel according to capillary forces is pinned at the junction.

14. The open-channel microfluidic diode of claim 10, wherein fluid flowing from the second channel to the first channel according to capillary forces flows freely across the junction.

15. A method of fabricating a microfluidic diode, the method comprising:
fabricating a first channel having a first cross-sectional area a_{S}; and
fabricating a second channel having a second cross-sectional area a_{L}, wherein the second channel overlaps with the first channel to form a junction between the first channel and the second channel.

16. The method of claim 15, wherein fabricating the first channel includes fabricating a first reservoir in fluid communication with the first channel.

17. The method of claim 16, wherein a depth of the first channel is approximately equal to the depth of the first reservoir.

18. The method of claim 15, wherein fabricating the second channel includes fabricating a second reservoir in fluid communication with the second channel.

19. The method of claim 18, wherein a depth of the second channel is approximately equal to the depth of the second reservoir.
